(19) United States
(12) Patent Application Publication
(10) Pub. No.: US 2019/0333057 A1
(43) Pub. Date: Oct. 31, 2019

(54) SYSTEMS AND METHODS IMPLEMENTING AN INDEPENDENT DEVICE-BASED SUB-NETWORK OF A DISTRIBUTED LEDGER NETWORK

(71) Applicant: Jeremie Miller, Reno, NV (US)

(72) Inventor: Jeremie Miller, Reno, NV (US)

(21) Appl. No.: 16/396,009

(22) Filed: Apr. 26, 2019

Related U.S. Application Data
(60) Provisional application No. 62/663,932, filed on Apr. 27, 2018.

(51) Int. Cl. G06Q 20/38; G06Q 20/34

(52) U.S. Cl. CPC G06Q 20/389; G06Q 2220/00; G06Q 20/351; G06Q 20/3829

(57) ABSTRACT

Systems and methods of implementing a distributed ledger network include: implementing a plurality of distributed computing systems in cooperative communication via a network and that define a distributed ledger network, wherein: each of the plurality of distributed computing systems includes a distinct validating node that performs validating services and cooperatively perform consensus services with each validating node of each of the plurality of distributed computing systems; interacting with a plurality of participating devices, wherein: each of the plurality of participating devices include a secure hardware element, a microledger virtual card that independently of the distributed ledger network records attestations by a participating device of transactions and transfers or receives cryptographically-based value based on the one or more transactions, and based on establishing a network connection to the distributed ledger network, each of the plurality of participating devices reconciles an associated microledger virtual card to the distributed ledger network.

### CROSS-REFERENCE TO RELATED APPLICATIONS

This application claims the benefit of U.S. Provisional Application No. 62/663,932, filed 27 Apr. 2018, which is incorporated herein in its entirety by this reference.

### TECHNICAL FIELD

This invention relates generally to the distributed ledger field, and more specifically to a new and useful systems and methods for deploying a distributed ledger for resource-constrained networked devices in the distributed ledger and networked-devices fields.

### BACKGROUND

Distributed ledger technology has proven utility across varied applications for high accuracy data accounting. However, modern distributed ledger technology may be ill-suited for industrial-scale Internet-connected systems and resource-constrained devices. Additionally, because many of these resource-constrained devices often operate with limited networking requirements and interact across dynamic sets of business entities, new systems and methods that enable a participation of these resource-constrained devices with a distributed ledger are required.

More specifically, resource-constrained devices, such as industrial IoT devices, are often required to operate for long periods (e.g., many years) and function during some of these periods without Internet connectivity. However, entities deploying or that may be associated with such devices must be able to manage the storage and dissemination of data generated by these resource-constrained devices.

Thus, there is a need in the distributed ledger and networked devices fields to create a distributed ledger and implementation techniques that may be implemented locally and privately between resource-constrained networked devices and publicly between the resource-constrained devices and the distributed ledger. The below-described embodiments of the present application address the one or more technical problems described herein and provide such advanced distributed ledger and associated implementation techniques and systems.

### SUMMARY OF THE INVENTION

In one embodiment, a distributed ledger network and system includes a plurality of distributed computing systems in cooperative communication via a network and that define a distributed ledger network, wherein: each of the plurality of distributed computing systems includes a distinct validating node that performs validating services and cooperatively perform consensus services with each validating node of each of the plurality of distributed computing systems; a plurality of participating devices, wherein: each of the plurality of participating devices include a secure hardware element, a microledger virtual card that independently of the distributed ledger network records one or more attestations by a participating device of one or more transactions and transfers or receives cryptographically-based value based on the one or more transactions, and based on establishing a network connection to the distributed ledger network, each of the plurality of participating devices reconciles an associated microledger virtual card to the distributed ledger network.

In one embodiment, a number of the plurality of distinct validating nodes operate to define a token space based on a joint consensus and a threshold group signature ascribed to genesis statement of the token space.

In one embodiment, the threshold group signature is based on a distributed key generation technique, wherein the distributed key generation technique automatically generates a cryptographic signing key for a transaction based on a receipt of a cryptographic signature from at least a minimum threshold number of the plurality of distinct validator nodes.

In one embodiment, the token space is defined by a subset of addressable storage across the distributed ledger network, and the token space is managed by a set of the plurality of distinct validators defining a token space management group appointed based on consensus between the plurality of distinct validators and cryptographically signed by a threshold cryptographic signature of the plurality of distinct validators.

In one embodiment, each respective microledger virtual card is cryptographically bound to the secure hardware element of each of the plurality of participating devices.

In one embodiment, reconciling the microledger virtual card to the distributed ledger network includes: collecting a hash of a plurality of transactions that were attested to by a respective participating device of the plurality of participating devices and that were recorded via the microledger virtual card of the respective participating device; and collecting cryptographically-based value from the respective participating device based on a balance associated with the microledger virtual card; and validating by the plurality of validator nodes the hash of the plurality of transactions based on a consensus between the plurality of validator nodes and ascribing a threshold cryptographic signature to the hash of the plurality of transactions.

In one embodiment, reconciling the microledger virtual card to the distributed ledger network further includes: referencing the cryptographically signed hash of the plurality of transactions to a ledger period; and storing the cryptographically signed hash of the plurality of transactions to a storage application programming interface of the distributed ledger network.

In one embodiment, each microledger virtual card of each of the plurality of participating devices supports a plurality of distinct public/private key pair algorithms different from a public/private key pair algorithm associated with each respective microledger virtual card of each respective participating device.

In one embodiment, reconciling the microledger virtual card to the distributed ledger network includes: performing a validation of a plurality of microledger virtual cards of the plurality of participating devices on a per-card basis thereby validating by the plurality of distinct validators transactions from a single microledger virtual card of the plurality of the microledger virtual cards.

In one embodiment, a set of the plurality of distinct validators defining a token space management group configure the microledger virtual card with cryptographic-based value and a expiry, wherein the expiry defines an occurrence or set time that causes the microledger virtual card to become inoperable for performing transactions.

In one embodiment, the plurality of distinct validators defining the token space management group configure each respective participating device with a respective microledger virtual card based on proof of an onboard secure hardware element for storing and managing cryptographic keys.

In one embodiment, upon the expiry of the microledger virtual card, the distributed ledger network reclaims unutilized value associated with the microledger virtual card.

In one embodiment, the distributed ledger network is implemented over an IPv6 network layer protocol.

In one embodiment, the microledger virtual card is allocated addressable storage based on a partition from the subset of addressable storage of the token space.

In one embodiment, a method of implementing a distributed ledger network, includes implementing a plurality of distributed computing systems in cooperative communication via a network and that define a distributed ledger network, wherein: each of the plurality of distributed computing systems includes a distinct validating node that performs validating services and cooperatively perform consensus services with each validating node of each of the plurality of distributed computing systems; interacting with a plurality of participating devices, wherein: each of the plurality of participating devices include a secure hardware element, a microledger virtual card that independently of the distributed ledger network records one or more attestations by a participating device of one or more transactions and transfers or receives cryptographically-based value based on the one or more transactions, and based on establishing a network connection to the distributed ledger network, each of the plurality of participating devices reconciles an associated microledger virtual card to the distributed ledger network.

In one embodiment, a number of the plurality of distinct validating nodes operate to define a token space based on a joint consensus and a threshold group signature ascribed to genesis statement of the token space.

In one embodiment, the threshold group signature is based on a distributed key generation technique, wherein the distributed key generation technique automatically generates a cryptographic signing key for a transaction based on a receipt of a cryptographic signature from at least a minimum threshold number of the plurality of distinct validator nodes.

### BRIEF DESCRIPTION OF THE FIGURES

FIG. 1 illustrates a system 100 in accordance with one or more embodiments of the present application;

FIG. 2 illustrates a method 200 in accordance with one or more embodiments of the present application; and

FIG. 3 illustrates a schematic of an example participating device in accordance with one or more embodiments of the present application.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview

As discussed in the background, where current distributed ledger technology may fail in diverse and constrained network environments, the embodiments of the present application may function to allow networks to function normally when connectivity cannot be guaranteed or may be intermittent.

In one or more embodiments of the present application provide a publicly coordinated but privately usable distributed ledger that may be designed to facilitate or enable a generation of provable attestations of physical events or electronic transactions (e.g., virtual or digital transactions). Accordingly, the one or more embodiments may enable every transaction performed by or involving participating devices (e.g., independent machines) to be independently witnessed and cryptographically signed by the network of distributed ledgers until a consensus is reached among the members of the distributed ledger, after which a given transaction may be stored in some manner including off-chain, and accessible via an API (e.g., a ReST application programming interface (API) or the like).

To enable such embodiments and implementations, the embodiments of the present application define the concept of a microledger card. A microledger card as referred to herein preferably relates to a virtual entity that is cryptographically bound to a specific hardware element of a participating device for a period of time. This pattern may function to enable participating devices with secure hardware elements to prove locally and independent of a real-time or live attestation by the distributed ledger that they have been verified by the public distributed ledger.

### 2. System or Implementing an Independent-Machine Based Microledger

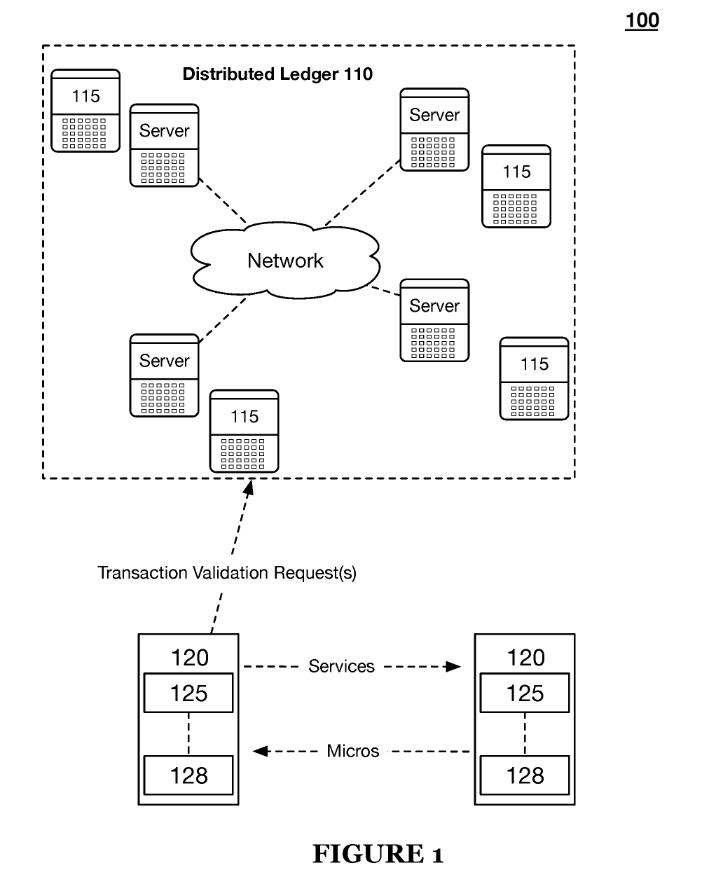

As shown in FIG. 1, the system 100 includes a distributed ledger network 110, a plurality of distinct validators 115, a plurality of participating devices 120 each having a secure hardware element 125 and a distinct microledger virtual card 128 stored thereon.

The distributed ledger network 110 preferably includes a plurality of distinct computing systems 112 that are in network communication (e.g., Internet, private network, etc.) for processing transactions in a distributed manner while each replicating and recording the transactions based on a consensus scheme/algorithm. For instance, the distinct computing systems 112 may interact and/or process transactions over a peer-to-peer network in which each of the distinct computing systems represent a peer in that system.

Each of the distinct computing systems 112 may implement a distinct validator 115 (validator node) that operates as a manager of the computing elements of the distinct computing systems. Accordingly, in such embodiments, the validator 115 may be an application layer that manages the consensus-based ledger operations of a given computing system 112.

A participating device 120 may include any suitable device, machine, and/or sometimes an application having secure hardware 125 and microledger virtual card 128. In the case of an application, the application preferably has access to a device having secure hardware 125. In a preferred embodiment, a participating device 120 may establish a network connection to the distributed ledger network 110 for purposes of divesting transactions to the distributed ledger network 110 and receiving consensus services. Preferably, the secure hardware 125 (e.g., an hardware security module, cryptographic processing chip and associated secure memory, and/or the like) includes a physical computing device that may function to safeguard and manage cryptographic keys and that may additionally function to provide cryptographic processing.

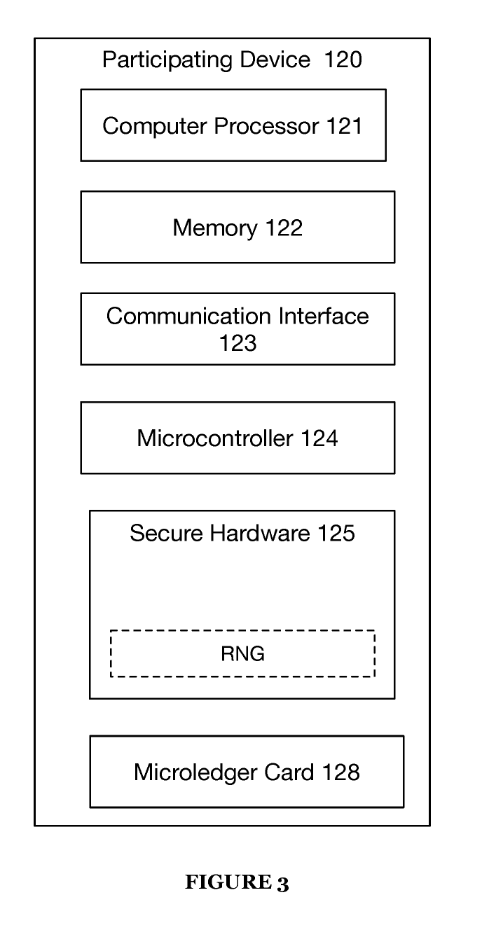

Each of the plurality of participating devices 120 operating within the network and system 100 may be any type of device, as illustrated by way of example in FIG. 3. For instance, each of the plurality of participating devices 120 may be an autonomous device. A participating device 120 of system 100 is preferably a device that is a principally independent actor from a central authority including any central server authority and including manufacturers of the autonomous device. That is, an autonomous device as referred to herein may be able to manage all of its operations, transactions, access, transacting with other devices, an operational control of the device without intervention of a central authority outside of the physical device. Thus, the autonomous device retains full control and complete privacy at the device, itself, when in use and operation.

As shown in FIG. 3, each of the plurality of participating devices 120 of system 100 comprises one or more computer processors 121 (or a main processor 121), a memory 122, a communication interface 123. In one variation, each participating device includes a microcontroller 124 having a small computer on a single integrated circuit containing a processor core, memory, and programmable input/output peripherals. The microcontroller 124, in some embodiments, is used in lieu of the one or more computer processors 121 and in other embodiments, the microcontroller is used in conjunction with the one or more computer processors 121. Additionally, and/or alternatively, each of the plurality of participating devices 120 includes a secure hardware element comprising cryptographic coprocessor which may be a hardware security module or similar secure component which provides high security and high-throughput cryptographic subsystems and a crypto-accelerator chip, which may be integrated with the cryptographic coprocessor. Each participating device 120 may also include a modulator, an oscillator, a timer/clock, and a power supply.

Each participating device 120 of FIG. 3 may also include traditional elements of a device configured for radio communication at the communication interface 123. Thus, the communication interface 123 of participating device 120 of a preferred embodiment may include a radio frequency (RF) scanner, RF transmitter, RF receiver, RF tuner, an antenna, and a RF amplifier.

The memory 122 of each participating device 120 in a preferred embodiment includes one or more computer-executable instructions and/or software applications with computer code for executing the functionality and protocols of DIST including Telehash and TMesh and any other functionality or protocols associated therewith, which are described herein required for secure and private communications by and between each of the plurality of participating devices 120 and another node.

The secure hardware element 125 using the cryptographic coprocessor of each participating device 120 may be configured to implement various cryptographic processes including generating, managing, and storing cryptography keys and encrypting and decrypting cryptographically secured communications. Specifically, each participating device 120 using the cryptographic coprocessor is able to generate public/private cryptography key pairs that can be used to cryptographically secure communication links and sessions between at least two participating devices.

Each of the plurality of participating devices 120 may be any type of device, which may be coupled with one or more machines, instruments, components, and/or real world operational devices or elements to sense inputs and/or outputs thereof, to perform actuation operations of one or more components thereof, to perform transactions on behalf of the element or device to which the participating device 120 is coupled, and the like. For example, in some embodiments, the participating device 120 comprises a sensor that is able to obtain readings and other information relating to or about one or more devices to which the sensor is operably coupled and/or obtain readings about the environment of the one or more devices.

Additionally, and/or alternatively, the participating device 120 may be an actuator that performs and/or controls one or more actuation operations of a device to which the actuator is a component and/or is operably coupled to. In yet another example, the participating device 120 may be a transaction device which brokers transactions on behalf of the device to which it is operably coupled and/or forms a component thereof. The transaction may include an exchange of value for a good, service, or other product offered to the participating device 120 or the device to which the participating device 120 is coupled. In such example, the participating device 120 acting as a transaction device is able to negotiate with other devices and/or other participating devices to obtain resources for itself and the device to which it is coupled or provide resources from the device to which it is coupled for a negotiated value or the like from another device or party.

### 3. Method for Implementing an Independent-Machine Based Microledger

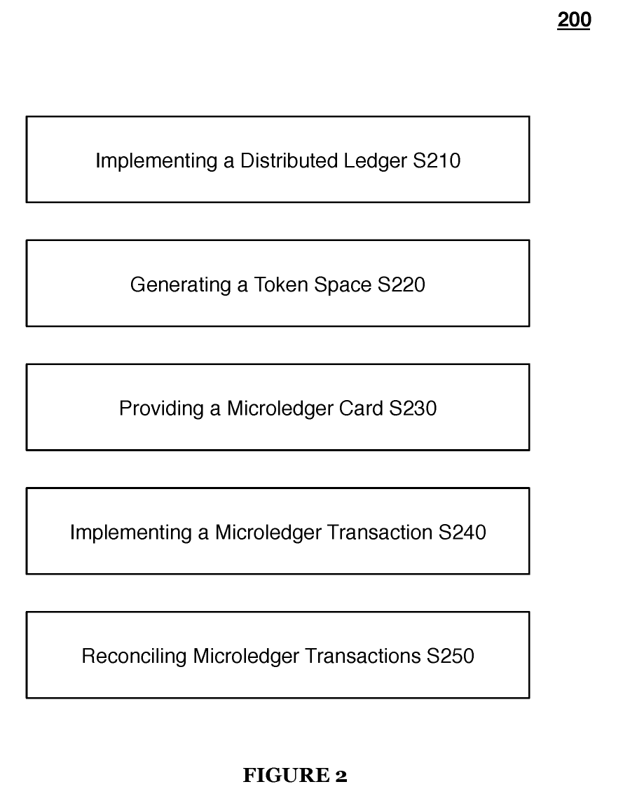

As shown in FIG. 2, the method 200 for implementing a machine-based microledger includes implementing a distributed ledger S210, generating a token space S220, providing a microledger virtual card S230, implementing a microledger-based transaction S240, and reconciling the microledger virtual card at the distributed ledger S250.

### 3.1 Public Ledger Architecture

S210, which includes implementing a distributed ledger, may function to enable distributed ledger network that cooperatively process transactions based on a consensus scheme or a consensus technique. In a preferred implementation, each of a plurality of validator nodes defining the distributed ledger network may cooperatively perform validation and/or process transactions based on a proof of accord consensus technique, as described in U.S. Provisional Application No. 62/678,602, which is incorporated herein in its entirety by this reference.

Preferably the distributed ledger network is a public ledger implemented via IPv6 thereby enabling each validator node implementing the distributed ledger network manages a sub-ledger or sub-network that may be a private network. However, it shall be noted that the distributed ledger network may be implemented with any suitable 16-byte Internet-based addressing protocol.

The validator nodes as referred to herein preferably relate to distinct management layer components of the distributed ledger network that operate in datacenters and may be distributed among distinct participating entities working together to maintain a state of the distributed ledger network, validating transactions in exchange for value (e.g., Micros, cryptocurrency, or the like), issuing new microledger virtual cards, managing a state of microledger virtual cards issued by the distributed ledger network. It shall be noted that a validator node may be referred herein interchangeably with the term “validator participant”.

3.1.1 Validator Authentication

Accordingly, S210 may function to define validator authentication requirements and/or validator authentication policy. In some embodiments, validator authentication requirements relate to requirements that should be met to successfully introduce a validator (node or participant) as a peer to a distributed ledger network.

In a preferred embodiment, S210 may function to define validator authentication requirements that include a certificate having strong security features identifying an entity, such as an organization, that manages the validator. In such embodiments, the certificated identity of the entity operating the validator may additionally or alternatively act as a recovery mechanism for recovering value of microledger virtual cards based on an expiration event or the like rendering a microledger virtual card useless unusable for performing transactions. For example, certificated identity of the validator comprises a cryptographically signed transport layer security (TLS) extended validation (EV) certificate.

Additionally, or alternatively, S210 may function to define validator authentication requirements that include obtaining or having a publicly accessible hostname that may be cryptographically signed by a TLS domain validated (DV) certificate. In such embodiments, a hostname of a validator may uniquely identify the validator within a distributed ledger network over time and enables the validator to participate as a single vote (or more) in the distributed ledger network. Preferably, to interact with the distributed ledger network, a validator should present a public HTTPS API or the like at its hostname for participating devices and software agents (or applications) to interact with the validator network.

Accordingly, a TLS EV and a TLS DV of a given validator together with a network address and a designated virtual card of the validator may function to define the validator authentication requirements to enable a registration of the validator within a validator network (i.e., the distributed ledger network, etc.) and operation of the validator as an active (e.g., voting, governing peer, etc.) participant.

In a preferred embodiment, the validator authentication requirements when presented to the validator network are distinctly inspected and validated by the existing validator participants of the network and accepted by a group threshold signature; meaning that the existing validator participants may vote on the presented validator authentication requirements thereby providing a consensus or not to include or exclude a given validator from the validator network. In such preferred embodiment, the consensus to the validator authentication requirements of a given validator enables the validator to become an active participant to the validator network for validating future transaction based on a consensus scheme (e.g., distributed key generation or the like).

### 3.1.2 Distributed Ledger Validator Selection

Additionally, or alternatively, implementing the distributed ledger network includes validator selection and/or validator elimination with respect to a validator network. Preferably, S210 enables any entity having a valid TLS certificate and at least a secure hardware wallet (secure cryptographic key store) to register to participate as a validator within a validator network. As mentioned above, S210 may require that existing validators to the validator network reach consensus on the registration of a given validator to enable the validator to be accepted and participate in subsequent distributed key generation to complete a registration of the validator and to become a voting peer within the validator network.

S210 may, additionally or alternatively, function to provide value incentives (e.g., cryptographic currency or value) to encourage existing validators to accept a new validator.

Additionally, or alternatively, S210 may enable a culling or elimination of any validator within the validator network based on a consensus. In such embodiments, a consensus to remove a validator should be accompanied with a valid removal reason or the like; some examples of valid removal reasons include, but are not limited to, non-participation, erroneous transaction validations, or other anomalous behavior and the like. Accordingly, a successful removal consensus by a threshold group of the existing validators of a network may function to trigger a new consensus vote or distributed key generation to reset the validating participants of the validator network to exclude the removed validator.

### 3.1.3 Distributed Ledger Consensus

For approving a variety of transaction, S210 may additionally, or alternatively require a consensus mechanism to be implemented between the validators of the validator network. For instance, a variety of the transactions may include, but are not limited to, governance of a token space or distributed ledger space, registration of new validators, attestations of a transaction, value transfers between entities (such as the distributed ledger and participating devices). In some embodiments, the consensus mechanism may include a processing of a proposed transaction to the validator network by cryptographically signing the proposed transaction using a threshold signature mechanism that includes reaching a simple majority among the existing validators by aggregating individual validator signatures or signature shares.

Accordingly, the threshold signature mechanism may operate by performing, by at least a majority or threshold number of validators of a network, a Distributed Key Generation (DKG) or similar technique. In some embodiments, a mere simple majority may be acquired and may be achieved by aggregating individual signatures from the distinct validators of a validator group or network.

In a specific implementation, a threshold (group) signature may function by causing the validators of a network to perform a DKG to produce a common group public cryptographic key from a series of individually generated private cryptographic key elements of each of the validators ascribing to the common group key. In such implementation, once a common group key is created or achieved by simple majority or by threshold majority, further participation from other validators cannot affect an outcome achieved by the common group key and consensus associated therewith.

### 3.1.4 Distributed Ledger Validator Periods

Additionally, or alternatively, S210 may function to implement a distributed ledger that include validator periods defining or representing a current height of a validated transaction chain. Accordingly, in some embodiments, a ledger period of the distributed ledger network comprises a predetermined amount of time (period) (e.g., 8 seconds or the like). The ledger period, in some embodiments, may be based on UNIX epoch or the like divided by eight (8) or right-shifted four (4) bits. In one or more embodiments, a ledger period length may be a simple 32-bit integer value.

Additionally, or alternatively, S210 may function to define or set a new ledger period based on a consensus of the validator network that is cryptographically signed with a threshold signature. In operation, S210 may function to augment or tag all transactions that are validated by the validator network with the most recent ledger period identifying a range of time in which the transaction was finalized by the validator network.

In one implementation, ledger transactions (e.g., payments, attestations, and registrations, and the like) may not actively be stored in the chain of periods per se. Rather, in this implementation, finalized and cryptographically signed transactions may reference a specific ledger period (indicating a ledger period in which it was finalized) in which they were signed by consensus of the validator network.

S210 preferably functions to store and make available finalized (validated) transactions via a storage API of a validator's network.

### 3.2 Token Genesis

S220, which includes constructing a token space or token, may function to create a distinct subnetwork of addressable space (e.g., IPv6, 16-byte system, or similar Internet Protocols) by designating a portion of all the addressable space of the distributed ledger network as the subnetwork. Any unallocated addressable space of the distributed ledger network may be partitioned to create a token space, which may be used to enable private transacting between disparate entities and the validating and storing of one or more details of the transaction.

Preferably, S220 functions to create the token space based on a threshold cryptographic signature of the validating participants of the distributed ledger network. That is, once at least a threshold group of the validating members cryptographical sign, using a public cryptographic key of a public/private key pair, a token space genesis statement, based on a distributed key generation scheme, S220 enables the separation of the designation subnetwork of addressable space for purposes of fulfilling one or more purposes of the genesis statement.

In a preferred embodiment, S220 may function to enable the validators to define governance policy for the given token space. The governance policy for the given token space, in some embodiments, may function to define the token management group that includes a subset of the validating participants that may be permitted to govern or manage the given token space. The selection and/or appointment of the token management group may be achieved based on a threshold signature of the validating participants of the distributed ledger network.

Additionally, or alternatively, once appointed, S220 may function to enable the token management group to define one or more operational attributes of the token space by voting that is confirmed by a threshold of the token management group and validating with a threshold group signature. For instance, the one or more operational attributes may include policy that identifies a total value of the token space. The total value of the token space may be represented as cryptocurrency value (e.g., 1,000,000 Micros) that is determined by the token management group and approved based on achieving a group threshold signature of the token management group. Additionally, or alternatively, the one or more operational attributes may define a number of microledger virtual cards that may be distributed, a portion of the total value that may be allocated to each microledger virtual card, an expiry for each microledger virtual card, requirements (e.g., secure hardware requirements, etc.) for provisioning a microledger virtual card to a participating device or machine, value reclamation policy, and/or the like. Any suitable policy or requirements may be attributed to a given token space so long as a threshold group signature is achieved and ascribed to the given policy or requirement for the token space.

In use, the token space within the distributed ledger network may function to provide inputs to microledger virtual cards and receive outputs from each of the microledger virtual cards. For instance, the token space may input cryptocurrency values to each of a plurality of microledger virtual cards and receive as outputs from each of the microledger virtual cards their stored outputs, which may include transactions which require validation and storing by the token space.

### 3.3 Microledger Virtual Card

S230, which includes providing a microledger virtual card, may function to generate a microledger virtual card for each of a plurality of devices that participate with processing transactions to the distributed ledger.

A microledger virtual card preferably relates to a virtual entity (or virtual accounting mechanism) that may be cryptographically bound to a specific hardware element of a participating device and, in some embodiments, the microledger virtual card may only be cryptographically bound to the secure hardware element of a participating device for a predetermined period (i.e., predetermined expiry, etc.). Alternatively, or additionally, in some embodiments, a microledger virtual card may be bound to a secure hardware element for a dynamic period that may expire based on an occurrence of one or more virtual or physical events. For instance, in some embodiments, a microledger virtual card may expire upon an expiration of a prescribed useful life of a participating device on which it is bound. In another example, a microledger virtual card may dynamically expire based on a completion of one or more predetermined transactions or other objectives of an entity deploying a participating device to which the microledger virtual card may be bound.

As mentioned above, a microledger virtual card may preferably be generated based on a threshold group signature of token management group of a given token space from which the microledger virtual card may be issued.

Specifically, in some embodiments, S230 may function to enable a generation of one or more or a plurality of microledger virtual cards for each of a plurality of participating devices. In such embodiments, S230 may function to enable a group of validator nodes operating and/or managing a given token ledger space to construct the plurality of microledger virtual cards according to or based on virtual card generation policy associated with the given ledger token space. For each microledger virtual card that is created within the token ledger space by the group of validator nodes, S230 may function to enable the group of validator nodes to attribute a preset crypto value, such as a cryptocurrency value (e.g., 1,000,000 Micros). In a preferred embodiment, S230 may attribute a cryptocurrency value comprising Micros. Micros may be the smallest units of exchange in a machine-to-machine transaction. Once a cryptocurrency value is attributed to a microledger virtual card and the microledger card is bound to a participating device, the cryptocurrency value may be managed, received, and distributed by the microledger virtual card when transacting attestations to reward the distributed ledger network for storing state of a microledger card, performing validations, and/or the like.

Additionally, or alternatively, for each microledger virtual card, S230 may function to enable the group of validators to attribute an expiration to each microledger virtual card, such that at the end an expiration event for a given microledger virtual card, any unused or maintained crypto value associated with the microledger virtual card may be reclaimed by the token ledger space.

Effectively, in a preferred embodiment, the microledger virtual card once cryptographically bound to a specific participating device creates and/or allows for a small-scale transaction ledger within the participating device. Thus, transactions that may be resultantly validated and absorbed by distributed ledger network may initially be performed and attested to by a participating device having the microledger virtual card independent of distributed ledger network. Thus, without network connectivity to a distributed ledger network a participating device, using the microledger virtual card, may perform distributed ledger transactions. Once connectivity between the participating device and the distributed ledger network is established, S230 may function to upload from the participating device to the distributed ledger network all ledger transactions documented or attested to via the microledger virtual card.

In some embodiments, S230 may functionally enable a microledger virtual card to adopt and/or interact with various and/or different cryptographic primitives (e.g., prime 256v1, secp256k1, curve25519, zk-SNARKs, etc.) that may be distinct from a basis cryptographic primitive of the genesis token space from which the microledger virtual card originated. That is, a microledger virtual card may be configured to support distinct public/private cryptographic key algorithms for operating with distinct ledger-types from its own. In such embodiments, a microledger virtual card tether to a first participating device operating and/or transacting using a first cryptographic-based value or currency may interact and/or transact with a second participating device that operates and/or transacts with a second cryptographic-based value or cryptocurrency. Accordingly, in a transaction in which a second participating device exchanges a second crypto-based value, the receiving participating device operating using a first crypto-based value may function to validate whether the second crypto-based value is an acceptable form of value based on verifying a public cryptographic key of the distributed ledger that originates the second crypto-based value. If the public cryptographic key of the distributed ledger is recognized and validated as good, the participating device may function to accept the second crypto-based value in exchange for performing one or more services. As an alternative or additional for proving a valid crypto-based value, a participating device may present an attestation from a virtual (crypto) wallet of the participating device verifying that a secure hardware exists on the participating device. The attestation and/or proof may be in the form of a verifiable certificate or the like.

### 3.4 Microledger-Based Transacting/Attestation

S240, which includes transacting using a microledger virtual card, may function to enable a participating device to perform private and local machine-based transactions independent of an active network connection with a distributed ledger network. That is, in one or more embodiments, the microledger virtual card of a participating device allows the participating device to perform a transaction using ledger-based value (e.g., cryptocurrency, Micros, etc.) in exchange for a service or in payment of a service. In an interim state in which network connectivity between the participating device and a distributed ledger network is not established, the microledger virtual card may function to record and/or reference one or more details of a transaction, receive value (based on a ledger-based address associated with the microledger virtual card), manage (crypto) value, perform attestation of a transaction using hashing, and the like.

An attestation as referred to herein preferably relates to a hash of some private data that is linked or chained to other or prior attestations by the inclusion of the previous attestation hash. Accordingly, an attestation may be the fundamental unit of an auditable record. As mentioned above, an attestation by a participating device using a microledger virtual card preferably includes a secure hash of private data, cryptographically signed and validated as part of a transaction involving a microledger virtual card. In association with the hash of transactions, S240 may function to associate or provide a reference within the microledger virtual card the value that is exchanged between the participants to the transaction. In a preferred embodiment, an attestation may be issued from a participating device (e.g., embedded in a sensor, scanner, crane, cargo crate, etc.) having a provably secure hardware element that can store cryptographic keys and, in some instances, generate cryptographic keys and additionally be used to validate cryptographic proofs (e.g., key signatures, etc.).

In one example, an off-chain sequence of attestations may be constructed by a participating device and the participating device may present the sequence or hash of attestations in a transaction with the distributed ledger network so that each attestation in the off-chain sequence may be witnessed and validated by the public ledger network and resultantly, stored by the distributed ledger network in a suitably auditable manner (e.g., a storage API).

Additionally, or alternatively, S240 may enable a participating device to perform or execute a transaction that involves transferring (cryptographic) value and recording attestations in several primary forms including, but not limited to, an evented transaction, a locked transaction, and a domain transaction described in more detail below.

For instance, evented inputs and evented outputs may include transactions in which a public identifier (e.g., ledger address) of a microledger virtual card and the values exchanged in the transactions immediately impact a balance on a distributed ledger from which the microledger virtual card was issued. Accordingly, an evented transaction may enable participating devices that may have low or no connectivity to its distributed ledger network receive value at any time via the distributed ledger network. In such embodiments, the participating device may become aware of the added value to the ledger upon connecting to its distributed ledger network during a divestiture of one or more transactions to the distributed ledger network for consensus services.

By example, locked outputs may include an opaque hash that was created by combining a (cryptographic or data) secret and a microledger virtual card (public) identifier or the like. In such example, subsequent locked inputs may function to reveal the secret to claim an output. Accordingly, S240 in such embodiments may function to enable atomic swaps between microledger virtual cards either on-chain or between different distributed ledger networks that support the microledger virtual cards.

Domain inputs and outputs, for example, may be based solely on a use of a domain name as verified by a certificate mechanism, such as DV TLS (e.g., from letsencrypt, etc.). In such instances, the domain outputs may be the only form of unconfirmed transaction outputs in a microledger environment that enables value to be sent to a public domain name and subsequently received by an owner of the public domain name. Additionally, or alternatively, the outputs may also include meta-data usable by the public domain name (e.g., an email address or URL, etc.) when receiving value or data.

### 3.5 Consensus/Reconciliation Services

S250, which includes reconciling one or more microledger transactions, may function to enable a distributed ledger network to validate and cryptographically sign transactions from one or more participating devices. That is, in a preferred embodiment, upon establishing a network connection between a distributed ledger network and a participating device, S250 may enable the participating device or the like to present attested transactions to one or more validators associated with the distributed ledger network. Preferably, the participating device presents the attested transactions to the one or more validators that issued the microledger virtual card of the participating device.

Preferably, reconciling the one or more attested transactions by the distributed ledger network includes a transaction validation flow performed by the one or more validators. Specifically, in some embodiments, the transaction validation flow may include the one or more validators identifying a validly issued microledger virtual card of a participating device, which is presenting transactions to the distributed ledger network. In this step, in such embodiments, the validators may function to assess whether a cryptographic signature (most likely public key but can be a private key signature) ascribed to the microledger virtual card matches or can be validated against a cryptographic signature (e.g., a threshold group cryptographic signature) of a token management group issuing the card or matches a known/recognized cryptographic key or signatures of another distributed ledger.

Additionally, once the microledger virtual card of the participating device, the validation transaction flow of the one or more validators may include collecting attested transaction data and identifying whether the attested transactions (attestations) are consistently hashed from a prior attested transaction. Preferably, the attested transaction includes a copy of the transaction or transaction data witnessed by the participating device, a copy of the cryptographic attestation of the participating device to the transaction and the associated attestation chain (i.e., a cryptographic hash), and confirming an existence of value on the microledger virtual card of the participating device is available for transfer to the validators for processing the transaction(s) to the distributed ledger network.

Additionally, or alternatively, in some embodiments, a transaction may be determined as valid if the microledger virtual card has not expired.

Preferably, S250 enables the validators to perform validation on a per-card basis, such only transactions from a single microledger virtual card is performed at a time. Additionally, S250 may enable the validators to perform validation of the transactions of a given microledger virtual card on a per-transaction basis, such that transactions from the given microledger virtual card are processed independently rather than in groups. It shall be noted, however, that the validators may function to validate and/or process transactions of microledger virtual cards in any suitable manner, including multiple cards at one time (or in parallel for efficiency) and/or multiple transactions at a time.

Accordingly, in the transaction validation flow, if the validators successfully validate a transaction from a microledger virtual card and the transaction is validated based on a group threshold (cryptographic) signature of the validators, S250 may function to enable the validators to append a current period of the distributed ledger network with the validated transaction and cryptographically signs the transaction with a group (minimum) threshold signature of the validators. Accordingly, after a group signature of the validators has been ascribed to the validated transaction, S250 may function to store the output of the validated transaction across the distributed ledger network, preferably in a storage application programming interface (API). In a preferred embodiment, each output of a validated transaction from a microledger virtual card is assigned one address (e.g., an IPv6-based address) at which the transaction can be stored and referenced. The address is preferably associated with a token space of the distributed ledger network from which the microledger virtual card was issued.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

What is claimed:

1. A distributed ledger network and system comprising:
a plurality of distributed computing systems in cooperative communication via a network and that define a distributed ledger network, wherein:
each of the plurality of distributed computing systems includes a distinct validating node that performs validating services and cooperatively perform consensus services with each validating node of each of the plurality of distributed computing systems;
a plurality of participating devices, wherein:
each of the plurality of participating devices include a secure hardware element,
a microledger virtual card that independently of the distributed ledger network records one or more attestations by a participating device of one or more transactions and transfers or receives cryptographically-based value based on the one or more transactions, and
based on establishing a network connection to the distributed ledger network, each of the plurality of participating devices reconciles an associated microledger virtual card to the distributed ledger network.

2. The system according to claim 1, wherein
a number of the plurality of distinct validating nodes operate to define a token space based on a joint consensus and a threshold group signature ascribed to genesis statement of the token space.

3. The system according to claim 2, wherein
the threshold group signature is based on a distributed key generation technique, wherein the distributed key generation technique automatically generates a cryptographic signing key for a transaction based on a receipt of a cryptographic signature from at least a minimum threshold number of the plurality of distinct validator nodes.

4. The system according to claim 2, wherein
the token space is defined by a subset of addressable storage across the distributed ledger network, and
the token space is managed by a set of the plurality of distinct validators defining a token space management group appointed based on consensus between the plurality of distinct validators and cryptographically signed by a threshold cryptographic signature of the plurality of distinct validators.

5. The system according to claim 1, wherein
each respective microledger virtual card is cryptographically bound to the secure hardware element of each of the plurality of participating devices.

6. The system according to claim 1, wherein
reconciling the microledger virtual card to the distributed ledger network includes:
collecting a hash of a plurality of transactions that were attested to by a respective participating device of the plurality of participating devices and that were recorded via the microledger virtual card of the respective participating device; and
collecting cryptographically-based value from the respective participating device based on a balance associated with the microledger virtual card; and
validating by the plurality of validator nodes the hash of the plurality of transactions based on a consensus between the plurality of validator nodes and ascribing a threshold cryptographic signature to the hash of the plurality of transactions.

7. The system according to claim 6, wherein
reconciling the microledger virtual card to the distributed ledger network further includes:
referencing the cryptographically signed hash of the plurality of transactions to a ledger period; and
storing the cryptographically signed hash of the plurality of transactions to a storage application programming interface of the distributed ledger network.

8. The system according to claim 1, wherein
each microledger virtual card of each of the plurality of participating devices supports a plurality of distinct public/private key pair algorithms different from a public/private key pair algorithm associated with each respective microledger virtual card of each respective participating device.

9. The system according to claim 1, wherein
reconciling the microledger virtual card to the distributed ledger network includes:
performing a validation of a plurality of microledger virtual cards of the plurality of participating devices on a per-card basis thereby validating by the plurality of distinct validators transactions from a single microledger virtual card of the plurality of the microledger virtual cards.

10. The system according to claim 2, wherein
a set of the plurality of distinct validators defining a token space management group configure the microledger virtual card with cryptographic-based value and a expiry, wherein the expiry defines an occurrence or set time that causes the microledger virtual card to become inoperable for performing transactions.

11. The system according to claim 10, wherein
the plurality of distinct validators defining the token space management group configure each respective participating device with a respective microledger virtual card based on proof of an onboard secure hardware element for storing and managing cryptographic keys.

12. The system according to claim 10, wherein
upon the expiry of the microledger virtual card, the distributed ledger network reclaims unutilized value associated with the microledger virtual card.

13. The system according to claim 1, wherein
the distributed ledger network is implemented over an IPv6 network layer protocol.

14. The system according to claim 4, wherein
the microledger virtual card is allocated addressable storage based on a partition from the subset of addressable storage of the token space.

15. A method of implementing a distributed ledger network, the method comprising:
implementing a plurality of distributed computing systems in cooperative communication via a network and that define a distributed ledger network, wherein:
each of the plurality of distributed computing systems includes a distinct validating node that performs validating services and cooperatively perform consensus services with each validating node of each of the plurality of distributed computing systems;
interacting with a plurality of participating devices, wherein:
each of the plurality of participating devices include a secure hardware element,
a microledger virtual card that independently of the distributed ledger network records one or more attestations by a participating device of one or more transactions and transfers or receives cryptographically-based value based on the one or more transactions, and
based on establishing a network connection to the distributed ledger network, each of the plurality of participating devices reconciles an associated microledger virtual card to the distributed ledger network.

16. The method according to claim 15, wherein
a number of the plurality of distinct validating nodes operate to define a token space based on a joint consensus and a threshold group signature ascribed to genesis statement of the token space.

17. The system according to claim 16, wherein
the threshold group signature is based on a distributed key generation technique, wherein the distributed key generation technique automatically generates a cryptographic signing key for a transaction based on a receipt of a cryptographic signature from at least a minimum threshold number of the plurality of distinct validator nodes.
